(19) United States
(12) Patent Application Publication
(10) Pub. No.: US 2007/0257202 A1
(43) Pub. Date: Nov. 8, 2007

(54) Luminescence Sensor Apparatus and Method

(75) Inventor: Dwight Sherod Walker, Durham, NC (US)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(73) Assignee: Glaxo Group Limited

(21) Appl. No.: 11/575,886

(22) PCT Filed: Sep. 13, 2005
(86) PCT No.: PCT/US05/32421

§ 371 Date: Mar. 23, 2007

Related U.S. Application Data
(60) Provisional application No. 60/614,191, filed on Sep. 28, 2004.

(51) Int. Cl. G01J 1/58

(52) U.S. Cl. 250/459.1; 250/458.1

(57) ABSTRACT

A system for use in analyzing a pharmaceutical composition having at least one constituent comprising a luminescence sensor having an integral low current light source, the sensor being adapted to direct a plurality of radiation pulses to the pharmaceutical composition and detect luminescence emitted from the composition constituent, the sensor being further adapted to provide at least one luminescence signal corresponding to the detected luminescence, and control means in communication with the sensor for controlling the sensor and analyzing the luminescence signal.

### FIELD OF THE INVENTION

The present invention relates generally to spectroscopic systems. More particularly, the invention relates to a method and apparatus for detecting on-line homogeneity and constituent concentration of pharmaceutical compositions, and the density of pharmaceutical mixtures.

### BACKGROUND OF THE INVENTION

A critical step in the preparation of a pharmaceutical composition, which often comprises a plurality of constituents, including the active drug(s), is mixing or blending. Indeed, it is imperative that the pharmaceutical composition is homogenous and has the required density to ensure that the appropriate dosage of the active drug(s) is delivered to a recipient.

The homogeneity and, of course, constituent concentration of pharmaceutical compositions are thus critical factors that are closely monitored during processing. Various conventional methods have been employed to determine the homogeneity and constituent concentration of pharmaceutical compositions. Most of the conventional methods are, however, complex and time consuming.

The conventional methods typically involve stopping the blender and removing nine (9) or more samples from various locations in the blender. The samples are then taken to a laboratory and analyzed. The blender remains shut down while the samples are analyzed, which can take from 24 to 48 hours to complete.

Another time consuming aspect of the traditional methods is the hit or miss approach to determine when the mixture is homogeneous. Typically, the blender is run for a pre-determined amount of time. The blender is then stopped and the samples are removed and analyzed. If the mixture is not homogenous, the blender is run again and the testing procedure is repeated.

Further, the mixture may reach homogeneity at a time-point before the pre-determined set time for blending. In the first case more testing is carried out than is required, and in the second case valuable time is wasted in blending beyond the end-point. It is also possible that over blending can cause segregation of the constituents (or components).

Finally, during compaction of the mixture, achieving the target density of the mixture is critical. Indeed, as is well known in the art, achieving the desired (or target) density of the composition is critical to achieving the proper weight and, hence, dose of the product.

Several apparatus and methods have been employed to detect on-line homogeneity. Illustrative are the apparatus and methods disclosed in Co-Pending application Ser. No. 10/363,291, entitled “Method and Apparatus for Detecting On-Line Homogeneity” and PCT Pub. Nos. WO 02/18921 A2 and WO 01/29539 A1.

In PCT Pub. No. WO 01/29539 A1, methods and systems that utilize luminescence to non-invasively analyze one or more components of a mixture are disclosed. In this instance, fluorescence is employed.

Although the disclosed systems overcome several of the above noted drawbacks associated with conventional methods and systems of determining homogeneity and concentration (i.e., potency) of constituents in pharmaceutical compositions, the system has several significant limitations. A major limitation is that the methods and systems are solely based on fluorescence emission from a target element. Because of the short timescale of fluorescence, measurement of the time-resolved emission requires sophisticated and costly optics and electronics. Further limitations are that the system requires fiber optic coupling and utilizes a high current light source.

In Applicant's PCT Application, i.e., PCT Pub. No. 01/29539 A1, a system for real-time fluorescent determination of trace elements is disclosed. The system includes a fluorometer that is adapted to provide two lines of incident radiation (incident radiation pulses). According to the invention, the first line of incident radiation is directed toward and substantially perpendicular to a first sample (i.e., blister strip) and, hence, sample path (designated generally SP₁) and the second line of incident radiation is directed toward and substantially perpendicular to a second path (designated generally SP₂). The radiation transmission means can also be adapted to provide one line of incident radiation to facilitate a single (rather than dual) blister strip process.

The first control means of the system generates and provides a plurality of incident radiation pulses of different wavelengths, preferably in the range of 200 to 800 nm. According to the invention, at least a respective one of the samples is illuminated with at least a respective one of the incident radiation pulses as it traverses a respective sample path SP₁, SP₂.

Although the noted system similarly overcomes many of the drawbacks associated with conventional methods of determining homogeneity and concentration of constituents in pharmaceutical compositions, the system potentially has several limitations. The limitations include the requirement of fiber optic coupling and synchronization for data collection

In U.S. Pat. No. 5,946,088 a further method of determining the homogeneity and drug concentration of constituents on pharmaceutical compositions is disclosed. The method involves the use of a modified “V”-blender having spectroscopic detection means disposed proximate the axis of rotation. The “V”-blender is adapted to provide “on-line” spectroscopic characteristics as the “V”-blender is rotated.

Although the method disclosed in the '088 patent also overcomes several of the above noted drawbacks associated with conventional methods of determining homogeneity and constituent concentration of pharmaceutical compositions, the method has several significant limitations. One significant limitation is that the method employs a “transflectance probe”, which similarly requires fiber optic coupling of the probe to the spectrometer. A further limitation is that the method requires synchronization of data collection.

It is therefore an object of the present invention to provide an apparatus and system for detecting on-line homogeneity and constituent concentration of pharmaceutical compositions that is readily adaptable to virtually all conventional blenders.

It is another object of the invention to provide an apparatus and system for detecting on-line mixture density of pharmaceutical compositions that is readily adaptable to virtually all processing apparatus, including conventional mixing, fill and compaction apparatus and systems.

It is another object of the invention to provide an apparatus, system and method for detecting on-line homogeneity, constituent concentration and density of pharmaceutical compositions that employs a luminescence sensor.

It is yet another object of the invention to provide an apparatus, system and method for detecting on-line homogeneity and constituent concentration of pharmaceutical compositions that includes control means to eliminate over mixing of the pharmaceutical composition.

### SUMMARY OF THE INVENTION

In accordance with the above objects and those that will be mentioned and will become apparent below, the invention provides apparatus, systems and methods for analyzing mixtures and, particularly, for analyzing mixtures during processing. The apparatus, systems and methods utilize luminescence to non-invasively analyze one or more constituents of the pharmaceutical composition. The analysis can provide a variety of compositional information, such as the chemical identity of a constituent in the pharmaceutical composition, the concentration of the constituent, the uniformity and density of the pharmaceutical composition and other information.

In one embodiment of the invention, the system for analyzing a pharmaceutical composition having at least one constituent comprises a luminescence sensor having an integral low current light source, the sensor being adapted to direct a plurality of radiation pulses to the pharmaceutical composition and detect luminescence emitted from the composition constituent, the sensor being further adapted to provide at least one luminescence signal corresponding to the detected luminescence, and control means in communication with the sensor for controlling the sensor and analyzing the luminescence signal.

Preferably, the power required to operate the sensor is in the range of approximately 5-25 volts.

In one embodiment of the invention, the light source comprises a plurality of light emitting diodes.

In one aspect, the light source comprises four light emitting diodes.

Preferably, each of the light emitting diodes comprises a blue light emitting diode.

In a preferred embodiment, each of the light emitting diodes has a wavelength in the range of approximately 300-650 nm and a power output in the range of approximately 2-5 milliwatts.

Preferably, the sensor includes a pulse generating circuit adapted to provide a pulsed cycle power input to the light source in the range of approximately 1-1000 Hz.

In one embodiment, the control means includes a control module adapted to control the activation and power input to the sensor and on analyzer for analyzing the luminescence signal.

Preferably, the control means further includes storage means for storing the luminescence signal and least one luminescence value corresponding to at least one luminescence characteristic of a predetermined constituent.

In another embodiment of the invention, the system for use in analyzing a pharmaceutical composition having at least one constituent includes a processing apparatus configured to process the pharmaceutical composition and a luminescence detection system operatively associated with the processing apparatus, the detection system including at least one luminescence sensor having an integral low current light source, the sensor being adapted to direct a plurality of radiation pulses to the pharmaceutical composition and detect luminescence emitted from the constituent, the sensor being further adapted to provide at least one luminescence signal corresponding to the detected luminescence, and control means in communication with the sensor for controlling the sensor and analyzing the luminescence signal.

In one aspect of the invention, the processing apparatus comprises a mixing apparatus.

In another aspect, the processing apparatus comprises a fill apparatus.

In another aspect, the processing apparatus comprises an apparatus adapted to transport the pharmaceutical composition during processing.

In one embodiment of the invention, the detection system includes a plurality of the sensors.

Preferably, the detection system is capable of non-invasively analyzing the pharmaceutical composition in real-time during processing of the pharmaceutical composition.

In a preferred embodiment of the invention, the detection system is capable of determining at least one of the following composition parameters: the identity of the pharmaceutical composition constituent, the concentration of the pharmaceutical composition constituent, the homogeneity of the pharmaceutical composition and the density of the pharmaceutical composition.

In one embodiment, the pharmaceutical composition includes at least one active constituent selected from the group consisting of salbutamol, salmeterol, budesonide, a beclomethasone ester and fluticasone ester.

The method of in-situ analysis of a pharmaceutical composition during processing in accordance with one embodiment of the invention comprises the steps of (i) providing a processing apparatus configured to process the pharmaceutical composition, (ii) providing a luminescence detection system operatively associated with the processing apparatus, the detection system including at least one luminescence sensor having an integral low current light source, the sensor being adapted and positioned to direct a plurality of radiation pulses to the pharmaceutical composition and detect the luminescence emitted form a constituent in the pharmaceutical composition, the sensor being further adapted to provide at least one luminescence signal corresponding to the detected luminescence, and control means in communication with the sensor for controlling the sensor, (iii) illuminating the pharmaceutical composition with at least a respective one of the plurality of radiation pulses, (iv) detecting the luminescence emitted from the pharmaceutical composition constituent, (v) and determining at least one characteristic of the pharmaceutical composition from the detected luminescence.

Among other advantages, the invention provides apparatus, systems and methods for non-invasively determining the homogeneity of a pharmaceutical composition and/or the concentration of a pharmaceutical composition constituent and/or the density of the pharmaceutical composition during processing. As a result, the process is not disturbed by the analysis and, hence, is generally not susceptible to sampling and measurement errors often associated with conventional invasive methods of analysis.

Further, the luminescence sensors and systems of the invention can be employed on-line and in real-time to provide compositional information during processing. This permits adjustment of processing variables and/or processing apparatus to optimize processing of the pharmaceutical processing.

The luminescence sensor of the invention also provides a strong signal, which results in a high sensitivity and specificity than achievable in NIR analysis. This higher sensitivity enables the luminescence sensor and systems and methods employing same of the invention to detect trace elements at low concentrations. The higher specificity further facilitates highly accurate identification of pharmaceutical composition constituents.

Further, the luminescence sensor and luminescence detection systems of the invention can be readily employed in conjunction with any number of types of processing apparatus and systems, especially apparatus used in pharmaceutical processing. The luminescence sensor is small in size, portable, and can be readily mounted at a variety of different locations on processing apparatus.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a perspective view of one embodiment of the luminescence sensor, according to the invention;

FIG. 2 is a sectioned perspective view of the sensor shown in FIG. 1;

FIG. 3 is a schematic view of one embodiment of a luminescence sensor, illustrating the components thereof, according to the invention;

FIG. 4 is a schematic illustration of the luminescence sensor LED orientation and focal point, according to the invention;

FIG. 5 is a schematic illustration of a luminescence detection system, according to the invention;

FIG. 6 is a perspective view of a blender for processing pharmaceutical compositions incorporating a luminescence sensor, according to one embodiment of the invention;

FIG. 7 is a perspective view of the blending tote for the blender shown in FIG. 6, illustrating the placement of a plurality of luminescence sensors, according to one embodiment of the invention;

FIG. 8 is a perspective view of a portion of a fill apparatus (i.e., compaction system) for processing pharmaceutical compositions incorporating a luminescence sensor, according to one embodiment of the invention;

FIG. 9 is a trace of a signal provided by a luminescence sensor during a blending process; and

FIG. 10 is a trace of a signal provided by a luminescence sensor during a fill/compaction process.

### DETAILED DESCRIPTION OF THE INVENTION

Before describing the present invention in detail, it is to be understood that this invention is not limited to particularly exemplified structures, apparatus, systems, materials or methods as such may, of course, vary. Thus, although a number of apparatus, systems and methods similar or equivalent to those described herein can be used in the practice of the present invention, the preferred apparatus, systems and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a”, “an”, “the” and “one” include plural referents unless the content clearly dictates otherwise. Thus, for example, reference to “a sensor” includes two or more such sensors; reference to “a constituent” includes two or more such constituents and the like.

### Definitions

The term “luminescence”, as used herein, refers to the emission of light from a pharmaceutical composition and/or a constituent thereof. As is well known in the art, the term “luminescence” includes fluorescence and phosphorescence, i.e., emission of light from triplet excited states.

The term “pharmaceutical composition”, as used herein, is meant to mean and include any compound or composition of matter or combination of constituents, which, when administered to an organism (human or animal) induces a desired pharmacologic and/or physiologic effect by local and/or systemic action. The term therefore encompasses substances traditionally regarded as actives, drugs and bioactive agents, as well as biopharmaceuticals (e.g., peptides, hormones, nucleic acids, gene constructs, etc.), including, but not limited to, analgesics, e.g., codeine, dihydromorphine, ergotamine, fentanyl or morphine; anginal preparations, e.g., diltiazem; antiallergics, e.g., cromoglycate (e.g., as the sodium salt), ketotifen or nedocromil (e.g., as the sodium salt); antiinfectives, e.g., cephalosporins, penicillins, streptomycin, sulphonamides, tetracyclines and pentamidine; antihistamines, e.g., methapyrilene; anti-inflammatories, e.g., beclomethasone (e.g., as the dipropionate ester), fluticasone (e.g., as the propionate ester), flunisolide, budesonide, rofleponide, mometasone (e.g., as the furoate ester), ciclesonide, triamcinolone (e.g., as the acetonide) or 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester; antitussives, e.g., noscapine; bronchodilators, e.g., 3-(4-{[6-({(2R)-2-hydroxy-2-[4-hydroxy-3-(hydroxymethyl)phenyl]ethyl}amino)hexyl]oxy}butyl) benzenesulfonamide, 3-(3-{[7-({(2R)-2-hydroxy-2-[4-hydroxy-3-(hydroxymethyl) phenyl]ethyl}amino)heptyl]oxy}propyl)benzenesulfonamide, 4-{(1R)-2-[(6-{2-[(2,6-dichlorobenzyl)oxy]ethoxy}hexyl)amino]-1-hydroxyethyl}-2-(hydroxymethyl)phenol, 2-hydroxy-5-((1R)-1-hydroxy-2-{[2-(4-{[(2R)-2-hydroxy-2-phenylethyl]amino}phenyl) ethyl]amino}ethyl)phenylformamide, 8-hydroxy-5-{(1R)-1-hydroxy-2-[(2-{4-[(6-methoxy-1,1′-biphenyl-3-yl)amino]phenyl}ethyl)amino]ethyl}quinolin-2(1H)-one, albuterol (e.g., as free base or sulphate), salmeterol (e.g., as xinafoate), ephedrine, adrenaline, fenoterol (e.g., as hydrobromide), formoterol (e.g. as fumarate), isoprenaline, metaproterenol, phenylephrine, phenylpropanolamine, pirbuterol (e.g., as acetate), reproterol (e.g., as hydrochloride), rimiterol, terbutaline (e.g., as sulphate), isoetharine, tulobuterol or 4-hydroxy-7-[2-[[2-[[3-(2-phenylethoxy)propyl]sulfonyl]ethyl]amino] ethyl-2(3H)-benzothiazolone; adenosine 2a agonists, e.g., 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g., as maleate); α₄ integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxy) acetyl]amino}pentanoyl)amino] propanoic acid (e.g., as free acid or potassium salt), diuretics, e.g., amiloride; anticholinergics, e.g., ipratropium (e.g. as bromide), tiotropium, atropine or oxitropium; hormones, e.g., cortisone, hydrocortisone or prednisolone; corticosteroids, e.g., (6α, 11β, 16α, 17α)-6,9-difluoro-17-{[(fluoromethyl)thio]carbonyl}-11-hydroxy-16-methyl-3-oxoandrosta-1,4-dien-17-yl 2-furoate, (6α, 11β, 16α, 17α)-6,9-difluoro-17-{[(fluoromethyl)thio]carbonyl}-11-hydroxy-16-methyl-3-oxoandrosta-1,4-dien-17-yl 4-methyl-1,3-thiazole-5-carboxylate, xanthines, e.g., aminophylline, choline theophyllinate, lysine theophyllinate or theophylline; therapeutic proteins and peptides, e.g., insulin or glucagon. The noted medicaments may also be employed in the form of salts, (e.g., as alkali metal or amine salts or as acid addition salts) or as esters (e.g., lower alkyl esters) or as solvates (e.g., hydrates) to optimize the activity and/or stability of the medicament.

The term “pharmaceutical composition” also encompasses formulations containing combinations of active ingredients, including, but not limited to, salbutamol (e.g., as the free base or the sulphate salt) or salmeterol (e.g., as the xinafoate salt) or formoterol (e.g., as the fumarate salt) in combination with an anti-inflammatory steroid, such as a beclomethasone ester (e.g., the dipropionate) or a fluticasone ester (e.g., the propionate) or budesonide.

The “pharmaceutical compositions”, alone or in combination with other actives (or agents), typically include one or more added materials or constituents, such as carriers, vehicles, and/or excipients. “Carriers,” “vehicles” and “excipients” generally refer to substantially inert materials that are nontoxic and do not interact with other components of the composition in a deleterious manner. These materials can be used to increase the amount of solids in particulate pharmaceutical compositions. Examples of suitable carriers include water, fluorocarbons, silicone, gelatin, waxes, and like materials. Examples of normally employed “excipients,” include pharmaceutical grades of carbohydrates including monosaccharides, disaccharides, cyclodextrins, and polysaccharides (e.g., dextrose, sucrose, lactose, raffinose, mannitol, sorbitol, inositol, dextrins, and maltodextrins); starch; cellulose; salts (e.g., sodium or calcium phosphates, calcium sulfate, magnesium sulfate); citric acid; tartaric acid; glycine; low, medium or high molecular weight polyethylene glycols (PEG's); pluronics; surfactants; and combinations thereof.

One additional component that can be employed in a pharmaceutical composition is one or more “derivatized carbohydrates”. The term “derivatized carbohydrates” is used herein to describe a class of molecules in which at least one hydroxyl group of the carbohydrate group is substituted with a hydrophobic moiety via either ester or ethers linkages. All isomers (both pure and mixtures thereof) are included within the scope of this term. Mixtures of chemically distinct derivatised carbohydrates may also be utilized.

Suitably, the hydroxyl groups of the carbohydrate can be substituted by a straight or branched hydrocarbon chain comprising up to 20 carbon atoms, more typically up to 6 carbon atoms. The derivatized carbohydrates can be formed by derivitisation of monosaccharides (e.g. mannitol, fructose and glucose) or of disaccharides (e.g. maltose, trehalose, cellobiose, lactose and sucrose). Derivatized carbohydrates are either commercially available or can be prepared according to procedures readily apparent to those skilled in the art.

Non limiting examples of derivatized carbohydrates include cellobiose octaacetate, sucrose octaacetate, lactose octaacetate, glucose pentaacetate, mannitol hexaacetate and trehalose octaacetate. Further suitable examples include those specifically disclosed in patent application WO 99/33853 (Quadrant Holdings), particularly trehalose diisobutyrate hexaacetate. A particularly preferred derivatized carbohydrate is α-D cellobiose octaacetate.

Typically, the aerodynamic size of the derivatized carbohydrates will be between 1 and 50 μm, and more particularly 1-20 μm. The derivatized carbohydrates for use in the preparation of compositions in accordance with this invention are typically micronized but controlled precipitation, supercritical fluid methodology and spray drying techniques familiar to those skilled in the art may also be utilized.

Suitably the derivatised carbohydrate is present in a concentration of 0.01-50% by weight of the total composition, preferably 1-20%. Other carriers such as, for example, magnesium stearate, can also be used in the formulations

The term “during processing”, as used herein, refers to any time during the production of a product from initial product component/ingredient formulation to final product delivery. “During processing” thus includes process development efforts, as well as, commercial manufacturing processes.

The term “active processing steps,” as used herein, refers to steps which involve actual processing of a pharmaceutical composition. In pharmaceutical processing, active processing steps can include bulk active production steps, bulk formulation steps (e.g., mixing, transportation, and the like) and fill and finishing steps (tablet and/or capsule formation).

The term “non-invasive,” as used herein, describes a measurement technique that does not require stopping or slowing down an active processing step while taking the measurement.

The term “on-line”, as used herein, means and includes data acquisition directly from a processing apparatus or during an active processing step.

The term “real-time”, as used herein, means and includes substantially simultaneously processing data as the data is received.

As indicated above, the present invention provides luminescence-based apparatus, systems and methods for analyzing pharmaceutical compositions (and mixtures thereof) on-line and in real-time. More particularly, the invention is directed to using luminescence to obtain compositional information of the pharmaceutical composition, such as the identity of the constituent in the composition, the concentration of a constituent and the uniformity and/or density of the pharmaceutical composition.

Various types of processing equipment, as described further below, can be configured to non-invasively analyze a pharmaceutical composition and/or mixtures thereof during processing using the luminescence sensors, systems and methods of the invention. As will be appreciated by one having ordinary skill in the art, the apparatus, systems and methods of the invention can also be used to analyze any number of different forms of mixtures (e.g., solids, slurries, etc.) and different components thereof.

In most embodiments, luminescence in at least one constituent or component of a pharmaceutical composition is induced by exposing the composition to light radiation in a technique referred to as luminescence analysis. However, in other embodiments, the natural luminescence of the constituent(s) may be measured.

Luminescence, as used herein, can utilize any type of electromagnetic radiation to induce luminescence. Preferably, ultraviolet and/or visible light is employed to induce luminescence.

As is well known in the art, in a luminescence technique the light radiation typically causes electronic transitions within the molecules of the components of the pharmaceutical compositions. These transitions, in many constituents (or elements), result in the emission of radiation (i.e., luminescence).

As is also well known in the art, constituents or elements have characteristic luminescence spectra depending upon their electronic structure. The spectra, thus, provides information regarding the composition of the material.

Luminescence analysis has several features which makes it particularly suitable for use in the systems and methods of the present invention. The emission rates of phosphorescence are typically slow. The phosphorescence lifetimes are thus typically milliseconds to seconds (compared to approx. 10 nanoseconds for fluorescence).

Further, luminescence analysis can be conducted non-invasively and, thus, processes do not have to be stopped or slowed in any manner during the analysis. In addition, luminescence analysis is a non-destructive technique; that is, the technique does not consume any material. Therefore, the composition of the material or mixture is generally unaffected by the analysis.

Luminescence analysis also provides a strong luminescence signal that can result in high-detection sensitivity. Consequently, small concentrations of constituents, in some instances, down to 0.1% or lower of the total mixture by weight, can readily be measured using the luminescence sensors and systems of the invention.

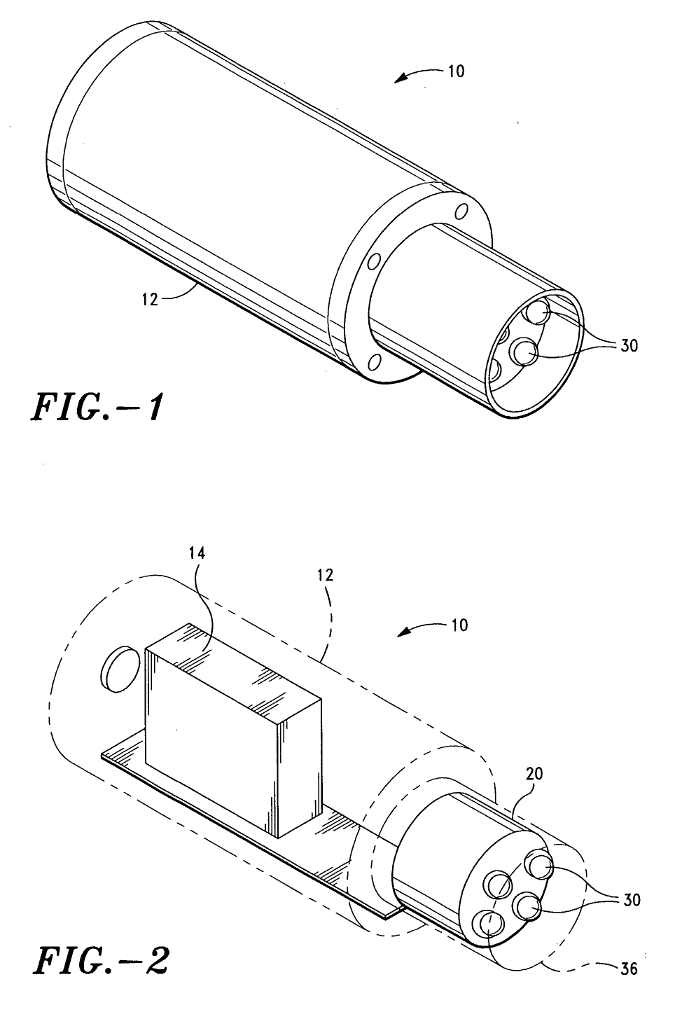

Referring now to FIGS. 1-3, there is shown one embodiment of the luminescence sensor 10 of the invention. As illustrated in FIG. 1, the sensor 10 generally includes an outer housing 12, a photomultiplier tube 20, a plurality of light emitting diodes (LEDs) 30 and a window 36, preferably, a sapphire window.

According to the invention, the housing 12 can comprise a single unit or a two piece unit, as shown in FIG. 1. The housing 12 can also comprise various light-weight, high strength materials, such as stainless steel, Inconel® and Hatstelloy®. In a preferred embodiment of the invention, the housing 12 comprises 316 stainless steel.

Referring now to FIGS. 2-4, the electronic system and related circuitry for the sensor 10 will be described in detail. Referring first to FIGS. 2 and 3, the sensor 10 includes a photomultiplier tube (PMT) 20, a high voltage power supply 22, which is in communication with the PMT 20 via line 21, a pulse generating circuit 24, which is in communication with the power supply 22 via line 23, a drive electronics circuit 26, which is in communication with the pulse generating circuit 26 via line 25, and power 27, ground 28 and signal 29 leads that are each in communication with the drive circuit 26.

In one embodiment of the invention, an on-off switch (not shown) is connected to the power supply 22 via power lead 27 to control activation of the sensor 10. In preferred embodiments, the on-off switch is designed to activate the sensor 10 based on a predetermined position or positions of the processing apparatus, e.g., position of blender during its rotation cycle. Such switches are well known in the art and generally include a position-detection mechanism.

In another aspect, the on-off switch is designed to activate at predetermined time intervals. In another aspect, the on-off switch is designed to activate the sensor based on a predetermined position of the processing apparatus and/or predetermined time interval(s).

In a preferred embodiment of the invention, the sensor 10 is controlled by the control means 42 of the invention. As discussed in detail below, the control means 42 preferably includes a control module 44 and an analyzer 46.

As is well known in the art, the PMT 20 provides several stages of amplification of incident photons via secondary emission from enclosed anodes. As discussed below, the PMT 20 detects the luminescence radiation and converts the signal to a voltage, which preferably is further processed by the analyzer 46.

As illustrated in FIG. 3, disposed proximate the forward end of the PMT 20 are a plurality of LEDs 30 that are preferably disposed on a circuit board 31. Disposed between the PMT 20 and circuit board 31 is a first visible filter 33, preferably, a yellow visible filter.

According to the invention, various high voltage power supplies 22 can be employed within the scope of the invention. Preferably, the high voltage power supply 22 provides in the range of approximately 100-900 volts, more preferably, in the range of approximately 300-600 volts.

Similarly, various LEDs 30 can be employed within the scope of the invention. Preferably, the LEDs 30 comprise blue light emitting diodes having a low wavelength, i.e., in the range of approximately 200-800 nm, more preferably, in the range of approximately 300-650 nm, and a power output in the range of 1-200 milliwatts, more preferably, in the range of 2-5 milliwatts. Applicants have found that the blue light emitting diodes provide sufficient power in the absorbance region of active pharmaceutical compositions to induce luminescence emission.

Referring now to FIG. 4, by employing low wavelength blue LEDs 30 having reasonable power (e.g., 2 milliwatts) and a low beam divergence (e.g., approx. 10°), a plurality of LEDs 30 can be focused onto a common point (designated “Fₚ”) to provide the desired illumination.

As illustrated in FIG. 1, in a preferred embodiment, four (4) LEDs 30 are employed. Preferably, the LEDs 30 are disposed in a substantially circular pattern and are focused on a point (Fₚ) in the range of approximately 2-40 mm from the face of the LEDs 30. More preferably, the focal point, Fₚ, is in the range of approximately 5-20 mm from the face of the LEDs 30.

As will be appreciated by one having ordinary skill in the art, additional LEDs can be employed to provide an enhanced focal point, Fₚ, and/or enhance the excitation illumination.

As indicated, in a preferred embodiment of the invention, a yellow visible filter 33 is disposed between PMT 20 and LEDs 30 to reduce reflected excitation illumination. Although various filters can be employed within the scope of the present invention, applicants have found that the yellow visible filter 33 provides optimum filtration (or blocking) of the illumination pulse while allowing the desired signal to pass therethrough.

According to the invention, the pulse generating circuit 26 is designed and adapted to provide a pulsed power input to the power supply 22 and, hence, PMT 20. Preferably, the pulse generating circuit 26 provides a pulsed cycle in the range of 1-1000 Hz, more preferably, in the range of 4-100 Hz.

As will be appreciated by one having ordinary skill in the art, the pulsed power input will reduce luminescence quenching of the sample. The operating life of the LEDs 30 will also be enhanced.

As illustrated in FIG. 2, the noted sensor components and related electronic are disposed in housing 12. Preferably, the components and electronics are hermetically sealed in the housing 12.

By virtue of the minimal, small electronics employed, the size of the housing 12 and, hence, sensor 10 is typically less than 20 cm in length and 5 cm in diameter. More preferably, the sensor 10 has a length less than 8.0 cm and a diameter less than 2.5 cm.

A key advantage of the sensor 10 of the invention is thus that the sensor 10 can be readily disposed in a 1 in. port on a blender (or mixer) or other processing equipment. Further, only a small DC voltage in the range of 5-10 volts is required for operation of the sensor 10.

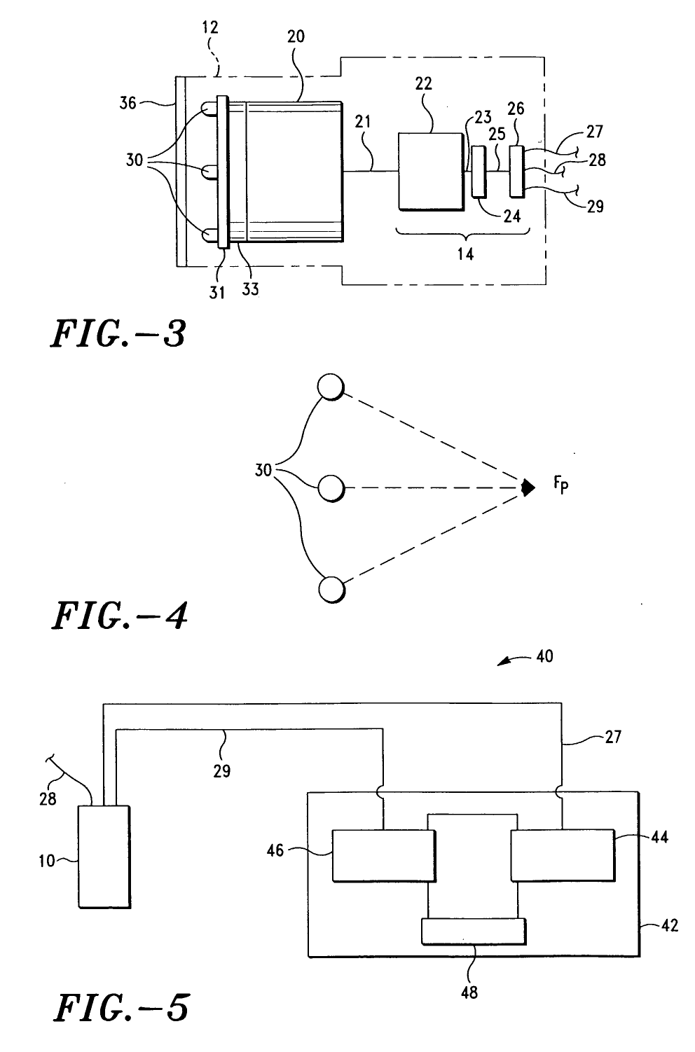

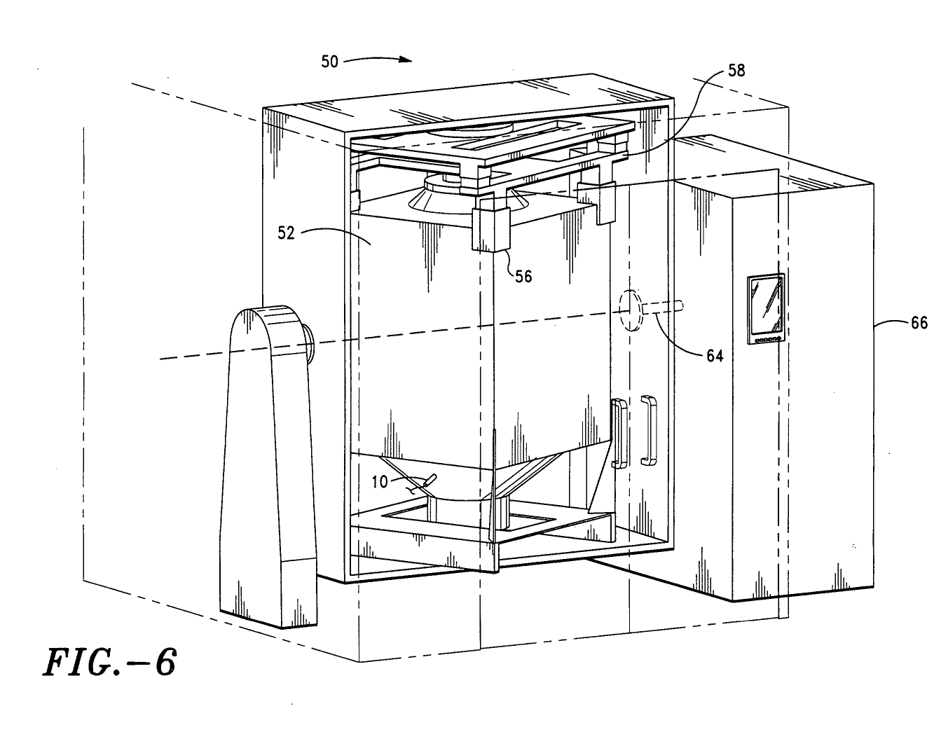

Referring now to FIG. 5, there is shown a schematic illustration of one embodiment of a luminescence detection system (designated generally 40) of the invention. The detection system 40 generally comprises the luminescence sensor 10, which is adapted to provide incident radiation to a pharmaceutical composition (or mixture) and detect the luminescence (emission) radiation from a constituent of the composition and, control means 42.

As illustrated in FIG. 5, the control means 42 preferably includes a control module 44 for controlling the power transmitted to the sensor 10 via power lead 27, an analyzer 46 for analyzing the emission radiation detected by the sensor 10, which is communicated to the analyzer 46 via signal lead 29, and storage means 48 adapted to store detected emission radiation and luminescence characteristics of known elements (or constituents) for comparison to detected emission radiation.

In a preferred mode of operation, the system 40 is activated and a power input in the range of approximately 5-25 volts is transmitted to the sensor 10, thus activating the LEDs 30, whereby the subject composition (or mixture) is illuminated with incident radiation pulses.

Preferably, the subject composition (or mixture) is illuminated with incident radiation over a pre-determined, suitable range of wavelengths (e.g., 200-800 nm) capable of inducing a luminescence response in at least one target element (or constituent). Applicant has found that the noted incident radiation wavelength range will induce a definitive luminescence response in trace elements and, in particular, active constituents, having a relative concentration in the range of 0.3-0.5%.

In response to the incident radiation, the target constituent emits luminescent radiation, a portion of which is filtered (via filter 33) and detected by the PMT 20. The luminescence signal is then converted to a DC voltage and transmitted to the analyzer 46, wherein the voltage signal is processed to determine the desired compositional information (e.g., active identification, active content, etc.). The compositional information can further be employed as a signal in a closed-loop control system to actively control one or more of the processing steps or apparatus.

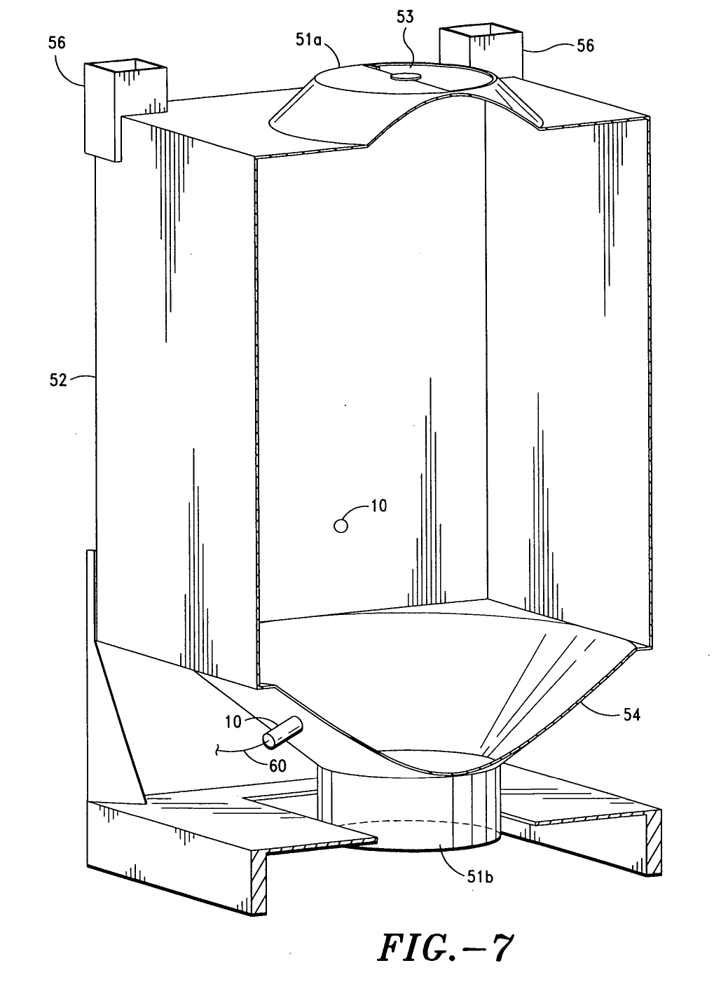

Referring now to FIGS. 6 and 7, there is shown one illustrated embodiment of a processing apparatus incorporating a luminescence sensor 10 of the invention. As illustrated in FIG. 6, in this instance, the processing apparatus comprises a “tote” blending system 50.

The blending system 50 is designated and configured to mix compositions of matter, such as powders or liquids, by rotating a “blending tote” 52 containing the composition of matter about an axis of rotation. The tote 52 typically has a height (H) in the range of 55″ in. to 65″ in. and is adapted to hold approximately 1586 liters of matter.

Referring to FIG. 7, the blending tote 52 includes a substantially rectangular section 54 and a substantially tapered section 56 disposed on the bottom end thereof. The tote 52 also includes a first opening 51a at the top of the tote 52 that is generally employed to charge the tote 52 with the individual compositions of matter that are to be mixed (or blended) and a second opening 51b at the bottom of the tote 52 that is generally employed to discharge the mixed, homogeneous composition. Openings 51a, 51b are covered and sealed during the mixing process by a conventional butterfly 53 or cone valves.

The tote 52 further includes a plurality of corner posts 56 adapted to removeably engage the mixer clamping frame 58. As illustrated in FIG. 1, a respective post 56 is disposed at each top corner of the tote rectangular section 52.

Further details of the basic blending system 50 and the components, operation and control thereof are set forth in Co-Pending application Ser. No. 10/363,291; which is incorporated by reference herein in its entirety.

Referring back to FIG. 7, in accordance with one embodiment of the invention, at least one luminescence sensor 10 is disposed in the tapered section 56 and rectangular section 54 of the tote 52. In alternative embodiments, a plurality of sensors 10 can be disposed in one or both sections 52, 54, or a single sensor 10 can be disposed in either section 52, 54 of the tote.

The sensor leads 27, 28, 29 are preferably disposed in a conduct 60, which is routed to and through port 62 in the axle assembly 64 to the control means 42, which is preferably disposed in housing 66.

It is to be understood that the blending system 50 is merely one example of a blending system that can readily accommodate the luminescence sensor 10 of the invention, systems and methods employing same. Indeed, as indicated above, the luminescence sensor 10 and detection system 40 can be readily employed on virtually all commercial pharmaceutical blending apparatus and systems.

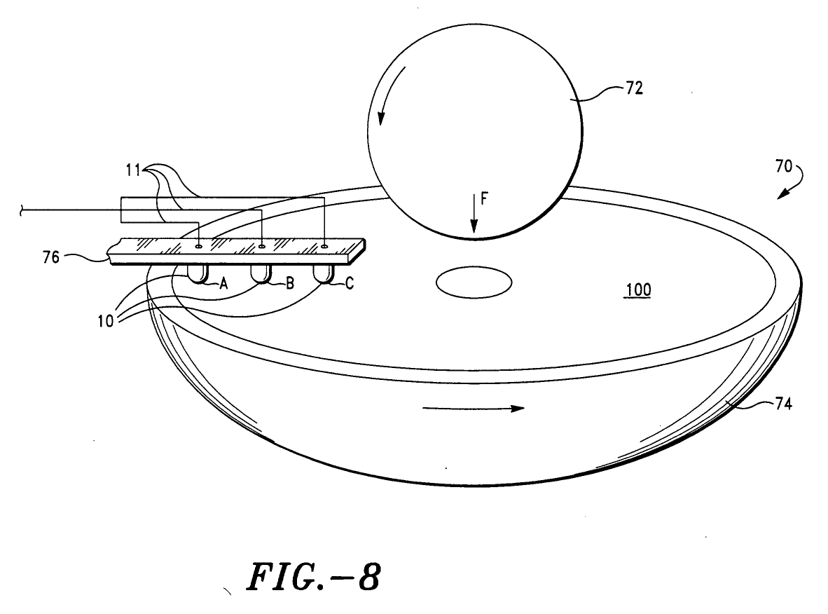

Referring now to FIG. 8, there is shown a schematic illustration of a further processing apparatus incorporating a luminescence sensor 10 of the invention. As illustrated in FIG. 8, in this instance, the processing apparatus comprises a fill apparatus having a composition compactor system or compactor 70.

The compactor 70 is designed and configured to compact and, hence, provide the desired bulk density of powder pharmaceutical compositions. As is well known in the art, during packaging of powered pharmaceutical compositions, the bulk density of the compositions needs to be held at or near constant to ensure that the proper amount of the composition is placed into each dose (e.g., blister). To maintain the bed density and uniformity a roller 72 is employed to apply a force (designated by Arrow “F”) to the powder bed (i.e., composition) 100.

Referring back to FIG. 8, the powder bed 100 is typically disposed in a rotatable compactor container 74. As the container 74 rotates, the roller 72 similarly rotates and applies a compaction force to the composition 100. Further details of the fill apparatus are set forth in U.S. Pat. No. 5,187,921; which is expressly incorporated herein in its entirety.

The current practice is to apply a constant force, F, to the composition 100. However, as will be appreciated by one having ordinary skill in the art, notwithstanding the application of a constant force, variances in the composition density will occur as the level of the bed 100 fluctuates.

To provide a real-time assessment of the density of the composition, at least one, preferably, a plurality of luminescence sensors 10 are disposed proximate the bed surface. As illustrated in FIG. 8, in a preferred embodiment, three (3) sensors 10 are employed. The sensors 10 are preferably disposed in a linear pattern extending from the outer periphery of the bed 100 toward the center of the container 74.

According to the invention, the frequency of the luminescence excitation (or cycle time) for each sensor 10 can be similar or different, depending on the residence time of the samples in the system's viewing area. In one embodiment, the pulse for each sensor 10 is as follows:
a. Sensor A=approximately 5-10 Hz
b. Sensor B=approximately 50-55 Hz
c. Sensor C=approximately 95-100 Hz
   The sensors 10 are preferably maintained in the desired positions via a sensor arm or member 76. The leads 27, 28, 29 (designated generally 11) for each sensor 10 are similarly routed to the detection system control means 42.

By virtue of the strategically placed sensors, a closed-loop control system can be employed, wherein a “variable” force can be provided by the roller 72 and applied to the bed 100 to ensure a uniform and accurate composition density.

As will be appreciated by one having ordinary skill in the art, the luminescence sensor 10 (or sensors 10) can similarly be employed on a variety of additional processing apparatus, such as the blister strip fill process disclosed in PCT Pub. No. WO 02/18921 A2; which is expressly incorporated by reference herein in its entirety.

### EXAMPLES

The following examples are provided to enable those skilled in the art to more clearly understand and practice the present invention. They should not be considered as limiting the scope of the invention, but merely as being illustrated as representative thereof.

### Example 1

A single luminescence sensor of the invention was disposed proximate a blending apparatus. The sensor included four (4) blue LEDs having a wavelength in the range of approximately 350-450 nm and a power output in the range of 2-10 milliwatts. The LEDs were configured to provide a focal point, Fₚ, approximately 20 mm from the top of the sensor. The sensor provided a frequency of luminescence excitation in the range of approximately 99-101 Hz.

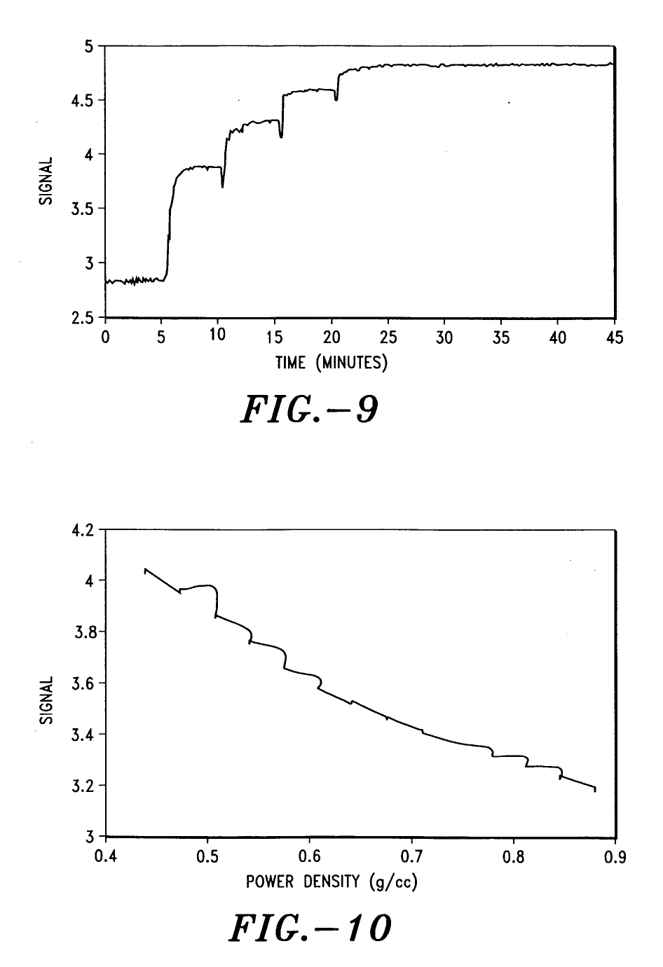

150 grams of lactose was placed in the blender and 4 subsequent equal additions of a fluorescent pharmaceutical active (i.e., salmeterol) were dosed by stopping the blender. The trace shown in FIG. 9 shows the signal measured by the sensor during the process. It can be observed that mixing was rapid and, in the absence of mixing, luminescence quenching also occurred rapidly

### Example 2

A single luminescence sensor similar to the sensor employed in Example 1 was disposed proximate a bed of a pharmaceutical composition (i.e., carrier and active) disposed in the compactor system of a fill apparatus. The sensor similarly included four (4) blue LEDs having a wavelength in the range of approximately 350-450 nm and a power output in the range of 2-10 mm. The LEDs were configured to provide a focal point, Fₚ, approximately 20 mm from the top of the sensor. The frequency employed was approximately 5 Hz.

The powder bed was compressed via a piston in 1 mm intervals. The trace shown in FIG. 10 shows the signal measured by the sensor during the process. The signal reflects an increase in luminescence emission as the density of the material is increased. As the sample volume is constant, the observed increase in luminescence corresponds to a greater abundance of active in the fixed volume due to the compression of the powder.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A system for use in analyzing a pharmaceutical composition having at least one constituent, said system comprising:
a luminescence sensor, said sensor having an integral low current light source, said sensor being adapted to direct a plurality of radiation pulses to the pharmaceutical composition and detect luminescence emitted from the constituent, said sensor being further adapted to provide at least one luminescence signal corresponding to said detected luminescence; and
control means in communication with said sensor for controlling said sensor and analyzing said luminescence signal.

2. The system of claim 1, wherein the power required to operate said sensor is in the range of approximately 5-25 volts.

3. The system of claim 1, wherein said light source comprises a plurality of light emitting diodes.

4. The system of claim 3, wherein said light source comprises four light emitting diodes.

5. The system of claim 3, wherein each of said light emitting diodes comprises a blue light emitting diode.

6. The system of claim 3, wherein each of said light emitting diodes has a wavelength in the range of approximately 300-650 nm.

7. The system of claim 3, wherein each of said light emitting diodes has a power output in the range of approximately 2-5 milliwatts.

8. The system of claim 1, wherein said sensor includes a pulse generating circuit adapted to provide a pulsed cycle power input to said light source in the range of approximately 1-1000 Hz.

9. The system of claim 8, wherein said pulse generating circuit provides a pulsed cycle power input to said light source in the range of approximately 4-100 Hz.

10. The system of claim 1, wherein said control means includes a control module adapted to control the activation and power input to said sensor and an analyzer for analyzing said luminescence signal.

11. The system of claim 10, wherein said control means further includes storage means for storing said luminescence signal and at least one luminescence value corresponding to at least one luminescence characteristic of a predetermined constituent.

12. A system for processing a pharmaceutical composition, the pharmaceutical composition having at least one constituent, said system comprising:
a processing apparatus configured to process the pharmaceutical composition; and
a luminescence detection system operatively associated with said processing apparatus, said detection system including at least one luminescence sensor, said sensor having an integral low current light source, said sensor being adapted to direct a plurality of radiation pulses to the pharmaceutical composition and detect luminescence emitted from the constituent, said sensor being further adapted to provide at least one luminescence signal corresponding to said detected luminescence, and control means in communication with said sensor for controlling said sensor and analyzing said luminescence signal.

13. The system of claim 12, wherein said processing apparatus comprises a mixing apparatus.

14. The system of claim 12, wherein said processing apparatus comprises a fill apparatus.

15. The system of claim 12, wherein said processing apparatus comprises an apparatus adapted to transport the pharmaceutical composition during processing.

16. The system of claim 12, wherein said detection system includes a plurality of said sensors.

17. The system of claim 12, wherein said detection system is capable of non-invasively analyzing the pharmaceutical composition in real-time during processing of the pharmaceutical composition.

18. The system of claim 12, wherein said detection system is capable of determining the identity of the pharmaceutical composition constituent.

19. The system of claim 12, wherein said detection system is capable of determining the concentration of the pharmaceutical composition constituent.

20. The system of claim 12, wherein said detection system is capable of determining the density of the pharmaceutical composition.

21. The system of claim 12, wherein said pharmaceutical composition includes at least one active constituent selected from the group consisting of salbutamol, salmeterol, budesonide, a beclomethasone ester and fluticasone ester.

22. A method of in-situ analysis of a pharmaceutical composition during processing, the pharmaceutical composition having at least one constituent that emits luminescence in response to applied radiation, the method comprising the steps of:
providing a processing apparatus configured to process the pharmaceutical composition;
providing a luminescence detection system operatively associated with said processing apparatus, said detection system including at least one luminescence sensor, said sensor having an integral low current light source, said sensor being adapted and positioned to direct a plurality of radiation pulses to the pharmaceutical composition and detect the luminescence emitted from the constituent, said sensor being further adapted to provide at least one luminescence signal corresponding to said detected luminescence, and control means in communication with said sensor for controlling said sensor;
illuminating the pharmaceutical composition with at least a respective one of said plurality of radiation pulses;
detecting the luminescence emitted from said pharmaceutical composition constituent; and
determining at least one characteristic of the pharmaceutical composition from said detected luminescence.
